(19) United States
(12) Patent Application Publication
(10) Pub. No.: US 2018/0222808 A1
(43) Pub. Date: Aug. 9, 2018

(54) REFRACTORY ARTICLE RESISTANT TO NON-FERROUS METAL AND PRODUCTION PROCESS THEREOF

(71) Applicant: VESUVIUS FRANCE SA, Feignies (FR)

(72) Inventors: Gilbert Rancoule, Feignies (FR); Christian Martin, Feignies (FR); Jean-Denis Nicolas, Feignies (FR); Loic Wisniewski, Feignies (FR)

(73) Assignee: VESUVIUS FRANCE SA, Feignies (FR)

(21) Appl. No.: 15/750,347

(22) PCT Filed: Aug. 2, 2016
(86) PCT No.: PCT/EP16/68456

§ 371 Date: Feb. 5, 2018

(30) Foreign Application Priority Data
Aug. 7, 2015 (EP) 15180260.0

(51) Int. Cl. C04B 41/50; C04B 35/14; C04B 38/00; C04B 41/00; C04B 41/85; C04B 41/52

(52) U.S. Cl. CPC C04B 41/5014; C04B 35/14; C04B 38/0058; C04B 41/009; C04B 2235/448; C04B 41/52; C04B 2235/3206; C04B 2235/3284; C04B 41/85

(57) ABSTRACT

A refractory article used at high temperature contains a silica, calcium silicate or mullite matrix with at least a surface having an open porosity filled at least partially with a sulfate, phosphate, or carbonate salt or a mixture of sulfate, phosphate or carbonate salts. The refractory article is resistant to the corrosion and build-up of non-ferrous metals and their alloys.

### BACKGROUND OF THE INVENTION

### (1) Field of the Invention

The present invention relates to refractory articles in general, which are in contact with liquid non-ferrous metals and alloys and in particular with liquid aluminum and its alloys such as rolls, riser tubes or rotary degassers for the treatment of aluminum, etc. and which are resistant to --these liquid non-ferrous metals at high temperature. The present invention also relates to a process to manufacture such refractory articles.

### (2) Description of the Related Art

Conveyed metal sheets are often treated against corrosion with liquid non-ferrous metals such as aluminum or zinc alloys containing aluminum. Rolls made of materials having a silica, calcium silicate or mullite matrix are well known for their excellent behavior at high temperature such as their high refractoriness and low thermal expansion and for their relative inertness with respect to molten metals. They are widely used in roll hearth furnaces. Although these rolls containing silica are commonly used, they present a drawback: while progressing in the furnace, the aluminum of the conveyed metal sheets starts to melt. Partially melted aluminum reacts with the silica of the ceramic roll body leading to aluminum oxidation (Al═>Al₂O₃) and silica reduction to metal form (mainly Si), reducing then drastically the life of the rolls due to corrosion.

It is known that, in order to prevent corrosion, rolls can be coated with SiAlON or with silicon nitride or silicon carbide. Such a non-wetting coating improves the lifetime of the rolls. However, these coatings are expensive and do not eventually prevent the infiltration of aluminum due to the porosity of such coating.

Even though the corrosion is reduced, some build-up phenomena still persist. By using a hard or durable silicon nitride coating, Si₃N₄ is slowly oxidized at the surface resulting in the formation of silica. Minor phases, such as silica coming from silicon nitride oxidation, react with aluminum producing Al₂O₃ and Si which accumulate on the coated roll surface, leading to driving issues.

A hard coating disclosed in US-A1-2007/089642 comprises silicon nitride particles and a binder comprising surface-modified nanoscale solid particles in an organic solvent. The coating is described as hard due to the strong adherence of the nitride coating to the substrate. This hard coating is usually applied on solar crucibles but can be also applied on riser tube in aluminum metallurgy to prevent the aluminum corrosion.

FR-A1-2707084 discloses a coating which exhibits stability to oxygen which is superior to at least that of silicon preventing liquid aluminum from reacting with silica. It consists of at least 80% of a refractory oxide chosen from the group including silica, lime, zirconia, titanium oxide, lithium oxide, alumina, magnesia or a mixture of these oxides and of at least 80% of magnesium silico-aluminate.

Besides aluminum resistant coating, US-A1-2005-127549 discloses a method of making an unfired refractory component that is resistant to molten aluminum by using a slurry comprising calcium silicate containing refractory material and barium or strontium containing compounds. It is believed the barium compound interacts with the hydrated calcium silicate compounds present in the refractory and modifies the crystal structure in such a way as to render the refractory matrix less susceptible to attack by molten aluminum.

FR-A1-2737488 also discloses a refractory material made of fused silica resistant to molten aluminum comprising at least 0.1 wt. % to a maximum of 10 wt. % of barium sulfate. Barium sulfate decreases the wettability of the matrix by molten aluminum. A coating made of this refractory material is also disclosed. According to this document, it is essential that the additive (barium sulfate) be poorly soluble in water.

The use of barium or strontium sulfate or carbonate is however not easy to implement in processes applying coating on refractory article and using water based slurries. The solubility of barium sulfate is 0.0023 g/l at 20° C. while the solubility of strontium sulfate is 0.135 g/L at 20° C. With such low solubility values, the number of layers which must be applied to have a sufficient amount of barium sulfate in the article porosity would be excessive and not feasible in industry.

All these coatings are creating a coated surface which is meant to avoid direct contact between silica and aluminum. However, since such coatings present some porosity, once aluminum begins to infiltrate, corrosion and build-up eventually occur.

The objective of the present invention is to provide a refractory article that will solve all the previously cited problems (corrosion and build-up of non-ferrous metals) and a process to manufacture such an article by impregnation with an aqueous slurry.

### BRIEF SUMMARY OF THE INVENTION

The present invention is defined in the attached independent claims. Preferred embodiments are defined in the dependent claims. In particular, the present invention concerns a refractory article according to claim 1. The sulfate, phosphate, carbonate salt or the mixture thereof present in the open porosity of the article surrounds the silica grains of the matrix within the refractory article and forms a barrier when the salt comes in contact with the non-ferrous metal. It is important that the salt decomposition temperature is higher than the temperature of use of the article. Otherwise, the salt would decompose before having fulfilled its function to protect the matrix grains. The temperature of use may be higher than 500° C., may be around 600° C. for a riser tube or higher than 900° C. for a roll. The definition of the salt also includes hydrogenated salt like Mg(HSO₄)₂. It is also necessary to have a highly soluble salt in water at 20° C. (higher than 100 g/l) in order to limit the number of layers to obtain a quantity of salt higher than 0.001 g/cm².

As direct interaction between the silica grains and the non-ferrous-metal is a key factor for build-up appearance, this barrier also reduces the probability of non-ferrous metal sticking to the article surface.

The present invention also relates to a process for producing such an article. A solution of 10-30 wt. % of sulfate, phosphate, carbonate salt or a mixture of thereof is applied on a refractory article and then dried in order to remove water. Suitable conditions are for example heating for two hours or more at 90° C. or more. The two operations can be repeated to increase the filling of the open porosity with the salt. The application can be made by painting, brushing, spraying or dipping the refractory article in the salt solution.

As the salt is in solution, once applied to the surface, some part of it remains on the surface of the refractory article but most of it penetrates in the open porosity and surrounds the silica grains. The refractory article is then dried.

A theory of the protection mechanism is presented wherein the non-ferrous metal is Al and the salt is magnesium sulfate (without the applicant to be bound thereto):

8 Al+3 Mg SO₄→4 Al₂O₃+3 Mg S (1)

4 Al+3 SiO₂→2 Al₂O₃+3 Si (2)

with the aluminum reacting preferably with the salt than silica, avoiding thereby the occurrence of reaction (2).

FIG. 1 represents the different steps of the phenomenon. After the application of the salt solution on the refractory article, the silica grains (2a) are surrounded by the salt (1) within matrix porosity.

At the temperature of use—around 600° C. for the riser tube or at higher temperature for roll—the salt which has a thermal decomposition temperature higher than the temperature of use reacts preferably with liquid aluminum. In a first step the salt which reacts is present on the surface. A thin alumina layer (3) is then formed on the surface and represents then a first protection barrier.

In a second step, liquid aluminum finishes to pass through the first barrier and infiltrates more deeply and reacts with the salt present in the open porosity. If liquid aluminum does not find any further salt, it starts reacting with the silica grains (2b). The invention does not prevent the corrosion but this phenomenon is surprisingly significantly slowed down due to the presence of MgSO4 in the surface porosity.

Trials have indeed shown a significant reduction of infiltration when the refractory article has the features of claim 1.

In a particular embodiment, the salt is present in a quantity of 0.001 to 0.1 g/cm². A surprisingly low quantity of salt 0.001 g/cm² is required. A sample with 0.0026 salt g/cm² was successfully tested. Above the higher value, the time of preparation of the article would be too high.

In a particular embodiment, the matrix is fused silica. This matrix has the advantage of being less sensitive to thermal shocks than other matrices.

Sodium and potassium salt should not be used when the temperature of use is around 900-1000° C. Sodium and potassium cations are known to disturb the network of inorganic phases and specifically the network of the fused silica phase. They break indeed the bonds Si—O—Si, the silica viscosity is then locally reduced. The silica tends to crystallize in the cristobalite form which is thermodynamically more stable than the amorphous form. Cristobalite presents one form at high temperature and one at low temperature. When cooling (thermal cycling can be important depending on the process) there is a transition from the high temperature cristobalite form to the low temperature cristobalite form. The consequence is a significant reduction of volume resulting in cracks, peeling which could end by the breakage of the refractory article. This phenomenon is less important when the cooling starts from 600° C.

The present invention also discloses a refractory article according to claim 1 wherein the salt present is zinc sulfate or magnesium sulfate. Zinc sulfate can be used for riser tube applications but not for rolls because the temperature of use of the roll is too high and the zinc sulfate starts to decompose leading to a lack of efficiency if not directly in contact with aluminum or its alloys during heating up. In that case MgSO₄ is preferred because it is stable at a temperature around 900-1000° C.

These two salts are also preferred because their solubility is high in water. Only one application of a high concentrated salt solution is required to substantially fill the open porosity of the refractory article.

In a preferred embodiment, the refractory article is a roll or a riser tube.

In one embodiment, a top coating is present on the surface of the refractory. For example, a top coating comprising at least 90 wt. % of Si₃N₄ and the remainder of SiO₂ is present. As mentioned here above silicon nitride coating is eventually infiltrated by aluminum. If the porosity of the refractory article is filled at least partially with sulfate, carbonate or phosphate salt, a further barrier is present leading to an extension of the life time of the roll.

The presence of the salt can result from different processes. For example, a process which comprises a first step of applying a solution of the salt on the refractory article, then drying the refractory article and then applying the top coating.

Another process comprises a step of mixing the salt with the top coating composition.

Another process comprises the application of the top coating composition on the refractory article, then applying the salt on this top coating. As the matrix and top coating presents some porosity, the salt solution will infiltrate the top coating and matrix at the same time, combining the advantage of both materials.

### BRIEF DESCRIPTION OF THE SEVERAL VIEWS OF THE DRAWINGS

FIG. 1 schematically illustrates the chain of phenomena;

FIG. 2a, 2b illustrate trials with example 1; and

FIG. 3a, 3b illustrate trials with example 2

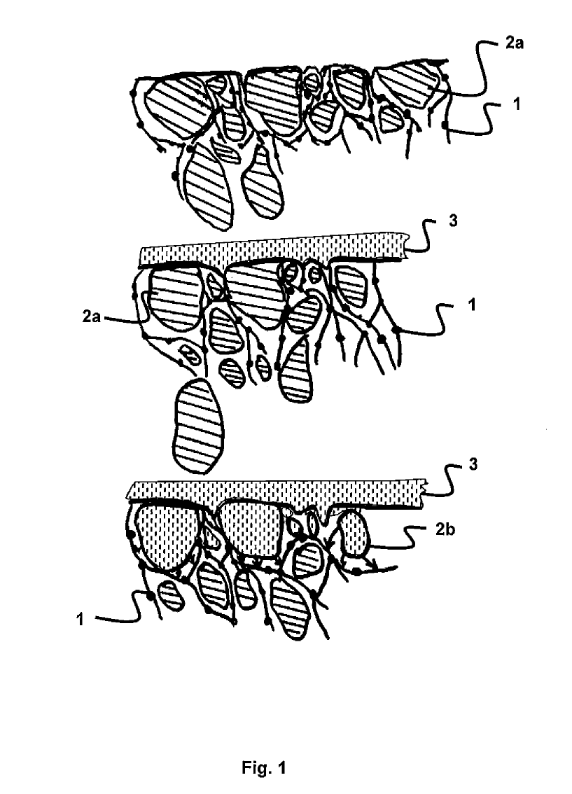

### DETAILED DESCRIPTION OF THE INVENTION

In order to better describe the invention, it will now be illustrated by means of examples that are not intended to limit the scope of the present patent application.

### EXAMPLE 1

An aqueous solution of 23 wt. % MgSO₄ is prepared. 1.79 g of this solution is painted on an internal surface of 37 cm² in a fused silica crucible (6). The quantity of the salt is around to 0.011 g/cm². The crucible was then filled with aluminum alloy powder (90 wt. % Al/10 wt. % Si) and heated at 1000° C. for 100 hours. The trial was also performed with a crucible without any protection. After cooling down of the crucible, the crucible and the solidified alloy (4) are cut in a transverse direction.

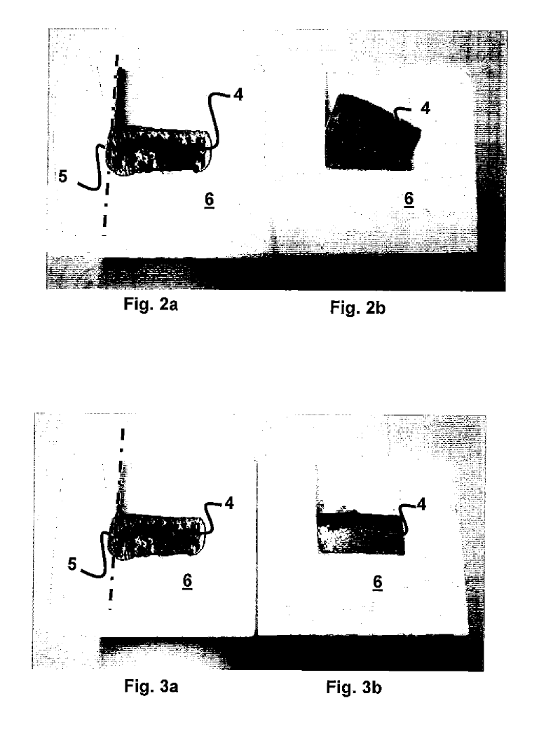

FIG. 2a (comparative example) clearly shows the infiltration of the alloy in the reference cup and the presence of Al₂O₃ (5). With the protection of MgSO₄, the corrosion is clearly limited: FIG. 2b shows the integrity of the silica crucible (6).

### EXAMPLE 2

A similar trial was carried out with a solution of ZnSO₄.

FIG. 3a (comparative example) clearly shows the infiltration of the alloy in the reference cup leading to the presence of Al₂O₃ (5). With the protection of ZnSO₄ (FIG. 3b), the corrosion is clearly limited.

It is to be noted that the protection occurs in this case because the alloy was in contact with the matrix infiltrated with ZnSO₄ during heating up. When reaching a temperature of 600° C., a layer of alumina is created at the interface between the metal melt and the crucible resulting in a protection at higher temperature. If the alloy is only put into contact with the refractory article after reaching temperatures above 700-750° C., this effect is lost due to thermal decomposition of ZnSO₄ before reaction with the alloy melt.

### EXAMPLE 3

An aqueous solution of 23 wt. % MgSO₄ is prepared. 97 g of this solution is applied by “painting” using a wet cloth on the external surface of silica rolls, two layers were painted on the surface with a drying time of about 5 min between the two layers. The rolls are then dried at 90° C. for at least 2 hours. The quantity of the salt is 0.0026 g/cm² of MgSO₄ on those rolls. These rolls were also tested in a furnace for the transportation of coated conveyed metal sheet at 930° C. for 6 months without corrosion or build-up having been reported.

1-14. (canceled)

15. Refractory article for use at high temperature having a silica, calcium silicate or mullite matrix with at least a surface having an open porosity wherein a sulfate, phosphate, carbonate salt or a mixture of thereof is present in the open porosity of at least a portion of at least a surface of the article and has a thermal decomposition temperature higher than 500° C. and wherein the solubility of the salt in water at 20° C. is higher than 100 g/l.

16. Refractory article according to claim 15 wherein the thermal decomposition temperature of the salt is higher than 900° C.

17. Refractory article according to claim 15 wherein the salt cation is neither sodium nor potassium.

18. Refractory article according to claim 15 wherein the salt cation is selected from the group consisting of magnesium and zinc.

19. Refractory article according to claim 15 wherein the silica is fused silica.

20. Refractory article according to claim 15 wherein the salt is present in a quantity of 0.001 to 0.1 g/cm².

21. Refractory article according to claim 15 wherein the salt is selected from the group consisting of magnesium sulfate and zinc sulfate.

22. Refractory article according to claim 15 wherein the refractory article is an article selected from the group consisting of a roll and a riser tube.

23. Refractory article according to claim 15 wherein a top coating is present on the surface of the refractory article.

24. Refractory article according to claim 23 wherein the top coating comprises at least 90 wt. % of Si₃N₄.

25. Process for the manufacture of a refractory article according to claim 15, comprising the steps of:
a) applying an aqueous solution of 10-30 wt % of a material selected from the group consisting of sulfate, phosphate, carbonate salt and a mixture of thereof on the refractory article,
b) drying the refractory article.

26. Process according to claim 11 wherein the first and second steps a) and b) are repeated.

27. Process according to claim 11 wherein the salt cation is selected form the group consisting of magnesium and zinc.

28. Process according to claim 11 further comprising a third step c) of applying a further coating.
